(19) United States
(12) Patent Application Publication
(10) Pub. No.: US 2017/0052820 A1
(43) Pub. Date: Feb. 23, 2017

(54) System and Method for Tracking Commitment Made by a User

(71) Applicant: Christian Hayden, Chicago, IL (US)

(72) Inventor: Christian Hayden, Chicago, IL (US)

(21) Appl. No.: 14/831,716

(22) Filed: Aug. 20, 2015

(51) Int. Cl. G06F 9/50; G06F 17/30; G06F 9/54

(52) U.S. Cl. CPC G06F 9/50; G06F 9/542; G06F 17/30386

(57) ABSTRACT

The present disclosure discloses a system and method for tracking the commitments made by a user. The system receives a commitment from a user to complete a plurality of tasks or to work for a pre-defined amount of time within a time frame. Subsequently, the system tracks the number of tasks or the amount of time spent within the time frame to which the user has committed. Further, the system analyzes the commitment made by comparing the number of tasks completed or the amount of time spent with the plurality of tasks or the pre-defined amount of time as committed. Based on the analysis, the system alerts the user of their progress in meeting the commitment made. The system distributes incentives or disincentives to the user based on the number of tasks completed or the amount of time spent at the end of time frame.

### TECHNICAL FIELD

The present disclosure relates to tracking commitment made by a user. More particularly, the present disclosure relates to a system and method for tracking the commitments made by a user and alerting the user of the commitment based on a deadline for that commitment.

### BACKGROUND

Generally, users may use a work management system to see tasks available for them. The work management system may act as an intermediate medium between entities and the users. The work management system may be used to assign tasks to the users such that they can work on the tasks to complete them.

In order to track the tasks performed by the users, the work management system may utilize a tracking method. Conventionally, the tracking method enables the entities to specify the tasks that are to be performed by the users. Often, the entities may utilize the work management system to assign tasks. The entities may assign a deadline or timeline to the users for completing a particular task. Generally, the entities may maintain records of a commitment within the work management system. The commitment may comprise the timeline within which the users are required to complete a given task. The tracking methods may show the commitment with respect to the tasks and may report a status of a given job, task, or a series of jobs or tasks performed. The tracking methods may also track the completion of the jobs. However, the existing tracking methods require either the entities to set the commitments, instead of the users who will be responsible for meeting them.

### SUMMARY

This summary is provided to introduce concepts related to systems and methods for tracking the commitments made by a user. The concepts are further described below in the detailed description. This summary is not intended to identify essential features of the disclosed subject matter nor is it intended for use in determining or limiting the scope of the disclosed subject matter.

In one implementation, a method for tracking a commitment made by a user is disclosed. The method comprises receiving, by a processor, a commitment from a user to complete a plurality of tasks or to work for a pre-defined amount of time within a time frame. The method further comprises tracking, by the processor, a number of tasks completed or amount of time spent in the pre-defined amount of time, at a given time. The given time is a time within or after the time frame. The method further comprises analyzing, by the processor, the commitment made by comparing the number of tasks completed or the amount of time spent with the plurality of tasks or the pre-defined amount of time as committed. The method further comprises alerting, by the processor, the user of their progress in meeting the commitment based on the analysis.

In one implementation, a system for tracking a commitment made by a user is disclosed. The system comprises a processor and a memory coupled to the processor. The processor executes program instructions stored in the memory to receive a commitment from a user to complete a plurality of tasks or to work for a pre-defined amount of time within a time frame. The processor further executes the program instructions to track a number of tasks of the plurality of tasks or amount of time spent in the pre-defined amount of time, at a given time. The given time is indicative of a time within or after the time frame. The processor further executes the program instructions to analyze the commitment made by comparing the number of tasks completed or the amount of time spent with the plurality of tasks or the pre-defined amount of time as committed. The processor further executes the program instructions to alert the user of their progress in meeting the commitment based on the analysis.

In one implementation, a non-transitory computer readable medium embodying a program executable in a computing device for tracking a commitment made by a user is disclosed. The program comprises a program code for receiving a commitment from a user to complete a plurality of tasks or to work for a pre-defined amount of time within a time frame. The program further comprises a program code for tracking a number of tasks of the plurality of tasks or amount of time spent in the pre-defined amount of time, at a given time. The given time is indicative of a time within or after the time frame. The program further comprises a program code for analyzing the commitment made by comparing the number of tasks completed or the amount of time spent with the plurality of tasks or the pre-defined amount of time as committed. The program further comprises a program code for alerting the user of their progress in meeting the commitment based on the analysis.

### BRIEF DESCRIPTION OF DRAWINGS

The detailed description is provided with reference to the accompanying figures. In the figures, the left-most digit(s) of a reference number identifies the figure in which the reference number first appears. The same numbers are used throughout the drawings to refer to like/similar features and components.

FIG. 1 illustrates a network implementation of a system for tracking the commitments made by a user, in accordance with one embodiment of the present disclosure.

FIG. 2 illustrates the system, in accordance with one embodiment of the present disclosure.

FIG. 3 illustrates a method for tracking the commitments made by a user, in accordance with one embodiment of the present disclosure.

### DETAILED DESCRIPTION

Systems and methods for tracking the commitments made by a user are disclosed. At first, the system prompts the user to enter future availability commitments. The user commits to completing available tasks within a time frame. Similarly, the user commits to work for a pre-defined amount of time within the time frame. The system tracks the number of tasks and/or the amount of pre-defined time to which the user has committed. In other words, the system tracks the time committed to complete certain tasks within the time frame by the user. Based on the tracking, the system analyzes the number of tasks or the amount of time spent and compares it with the commitment made at any given time within or after the time frame. Specifically, the system analyzes the commitment made by comparing the actual commitment made with the number of tasks completed and/or time spent on the tasks at the given time. Subsequently, the system generates an alert to notify the user of their progress in meeting the commitment based on the analysis such that the user can work on the remaining tasks to complete them. If the user meets their commitments within the time frame, then the system may distribute rewards/incentives to the user. Further, if the user does not meet the commitment within the time frame, then the system may distribute penalties/disincentives to the user.

While aspects of described system and method for tracking commitment made by a user may be implemented in any number of different computing systems, environments, and/or configurations, the embodiments are described in the context of the following exemplary system.

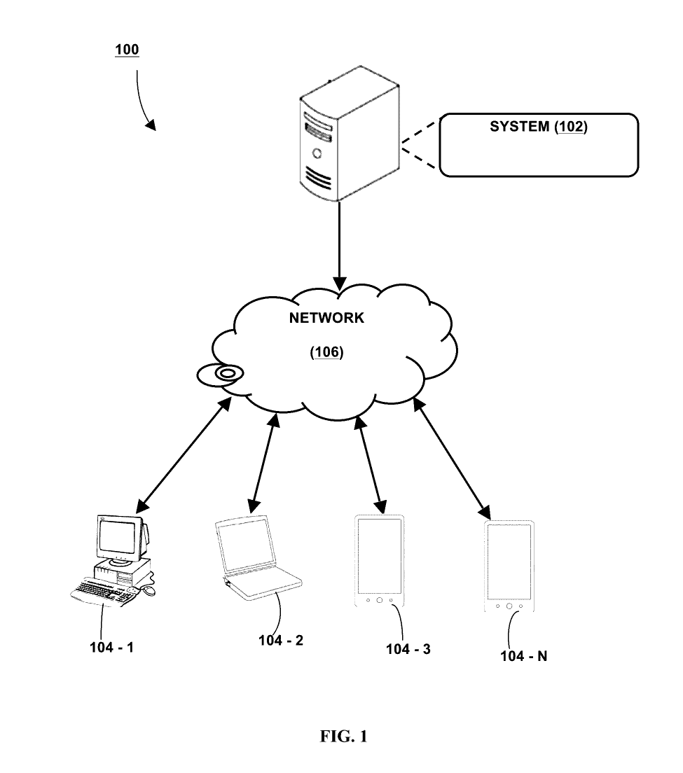

Referring now to FIG. 1, a network implementation 100 of a system 102 for tracking commitment made by a user is illustrated in accordance with an embodiment of the present disclosure. The system 102 may prompt the user on a user interface to enter their availability commitments. Subsequently, the system 102 receives a commitment from a user to complete a plurality of tasks or to work for a pre-defined amount of time within a time frame. The system 102 may track number of tasks completed or amount of time spent at a given time. The system 102 may analyze the commitment by comparing the number of tasks completed or the amount of time spent with the commitment made. Further, the system 102 may alert the user of their progress in meeting the commitment based on the analysis. The system 102 further distributes incentives or disincentives to the user based on the number of tasks of the plurality of tasks or the amount of time of the predefined amount of time spent at the end of the time frame. If the user meets the commitment within the time frame, then the system 102 distributes the incentives to the user. Similarly, the system 102 may distribute disincentives if the user does not meet the commitment within the time frame.

Although the present disclosure is explained by considering a scenario that the system 102 is implemented as an application on a server, it may be understood that the system 102 may also be implemented in a variety of computing systems, such as a laptop computer, a desktop computer, a notebook, a workstation, a mainframe computer, a server, a network server, and the like. It will be understood that the system 102 may be accessed by multiple users through one or more user devices 104-1, 104-2 . . . 104-N, collectively referred to as user devices 104 hereinafter, or applications residing on the user devices 104. Examples of the user devices 104 may include, but are not limited to, a portable computer, a personal digital assistant, a handheld device, and a workstation. The user devices 104 are communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

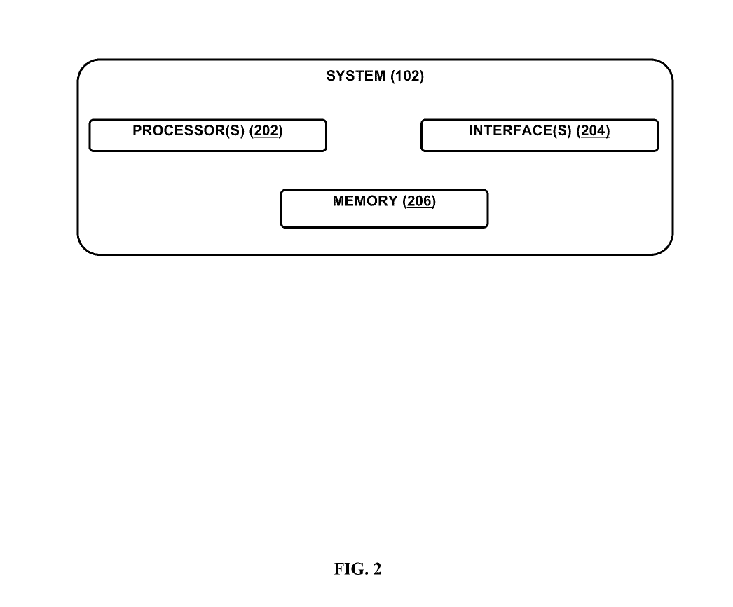

Referring now to FIG. 2, the system 102 is illustrated in accordance with an embodiment of the present disclosure. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to retrieve and execute computer-readable instructions stored in the memory 206.

The I/O interface 204 may include a variety of software and hardware interfaces; for example, a web interface, a graphical user interface, and the like. The I/O interface 204 may allow the system 102 to interact with a user directly or through the user devices 104. Further, the I/O interface 204 may enable the system 102 to communicate with other computing devices, such as web servers and external data servers (not shown). The I/O interface 204 may facilitate multiple communications within a wide variety of networks and protocol types, including wired networks; for example, LAN, cable, etc., and wireless networks, such as WLAN, cellular, or satellite. The I/O interface 204 may include one or more ports for connecting a number of devices to one another or to another server.

The memory 206 may include any computer-readable medium known in the art; including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 comprises routines, programs, objects, components, data structures, etc., which perform particular tasks or implement particular abstract data types. The memory 206 may include programs or coded instructions that supplement applications and functions of the system 102.

In one implementation, at first, a user may use the client device 104 to access the system 102 via the I/O interface 204. The user may register himself/herself to use the system 102. The user may register with the system 102 by providing certain details. In one implementation, the system 102 may be implemented in a work management system. The working of the system 102 is explained in detail using FIG. 2. The system 102 may be used for tracking the commitments made by the user. In order to track the commitment made, the system 102 receives a commitment from the user.

First, the system 102 may prompt the user to enter availability commitments for a plurality of tasks. A task may indicate a job that requires a specific qualification of a person or user to work and complete them. The task may require other factors to select the user to work and complete them, which is apparent to a person skilled in the art. In one example, a task may comprise reviewing medical charts, or medical coding, or other jobs that may be outsourced. Further, the system 102 may prompt the user to enter a pre-defined time to which the user can commit within a time frame. The time frame may indicate a deadline by which the user commits to complete the plurality of tasks committed.

In order to commit to the pre-defined time, the system 102 may show/present available tasks on the I/O interface 204. The tasks may be retrieved from an external database. In one example, the user may select at least one task that may be feasible for him/her to commit to completing. In one example, the user may select and commit to complete the task that may take less time and may be completed before a particular date. In another example, the user may commit to completing the task that aligns with his/her expertise within the time frame. Consider that the tasks available are related to medical charts that require users with expertise in reviewing the medical charts. For the tasks available, the user may commit to a particular date (time frame) to complete one or more tasks. Consider that the date on which a user makes a commitment is Aug. 1, 2015. Further, consider the user commits to complete 10 tasks by Aug. 10, 2015. In other words, the user commits to complete one task per day on average. The user may choose the time frame based on his/her availability. Availability indicates the time that the user anticipates being able to work on the tasks. Based on his/her availability, the user may input the number of tasks he may complete within the time frame as discussed above.

As known, some tasks may take more time to complete than anticipated. In order to adjust the time frame committed by the user, the system 102 facilitates an option to change/modify the pre-defined tasks to be completed and/or the time frame committed to by the user. In other words, the system 102 allows the user to vary the time frame and the pre-defined amount of time or the plurality of tasks to be completed within the time frame as committed at the first instance.

In one example, the system 102 may receive an input from the user. The input may include a certain amount of time such as 20 hours that the user commits to spend on the tasks within the time frame. The user may commit to different amount of times depending on the date. For example, the user may commit to completing four tasks on Aug. 1, 2015. Further, the user may commit to complete six tasks on Aug. 2, 2015. Similarly, the user may commit to spend a certain amount of time to be completed by a specific date. For example, the user may commit to spending 9.5 hours in a one week time period starting from Aug. 1, 2015. In another example, the user may commit to spending 10 hours between Aug. 1, 2015 and Aug. 10, 2015.

After receiving the commitments, the system 102 may track the commitments made by the user. The system 102 may track the number of tasks of the plurality of tasks or the amount of time spent in the pre-defined amount of time, at a given time within the time frame. The pre-defined time indicates the (total) time that the user commits to at first instance. The given time may indicate a time within or after the time frame. For example, consider the user commits to complete one or more tasks by a particular date (time frame). Consider that the date on which a user makes a commitment is Aug. 1, 2015. Further, consider the user commits to completing 10 tasks by Aug. 10, 2015. The system 102 may track the number of tasks completed on Aug. 5, 2015 to check status of the tasks completed. Similarly, consider the user has committed to spend 50 hours between Aug. 1, 2015 and Aug. 10, 2015. The system 102 may track the number of hours spent by Aug. 5, 2015 to check status of the number of hours spent. Further, the system 102 may track the number of tasks completed on Aug. 12, 2015 to check status of the tasks completed.

After tracking, the system 102 may analyze the commitment made by the user by comparing the number of tasks completed or the amount of time spent with the plurality of tasks or the pre-defined amount of time as committed. For example, if the user commits on Aug. 1, 2015 to complete ten tasks by Aug. 10, 2015, and the user wishes to track the status of the tasks on Aug. 8, 2015, then the system 102 analyzes the commitment on Aug. 8, 2015. Consider that the user has completed six tasks by Aug. 8, 2015. Then the system 102 may analyze the total number of tasks committed and number of tasks completed as of Aug. 8, 2015. After analyzing, the system 102 may inform the user that two tasks are left to complete. The system 102 analyzes the commitment such that when the user is not on track to meet the commitment, then the user is informed so that the user can complete the remaining tasks or spend the amount of time within the time frame. Similarly, the system 102 may analyze the amount of time spent with respect to the pre-defined amount of time to which the user committed. Consider the user has committed on Aug. 1, 2015, to work for 20 hours by Aug. 10, 2015. The system 102 may track the amount of time spent on Aug. 8, 2015. Consider the user has spent 10 hours between Aug. 1, 2015 and Aug. 8, 2015, and then the system 102 may analyze the total number of hours committed and the actual number of hours spent. After analyzing, the system 102 may inform the user that 10 hours are to be completed in the remaining two days as committed.

If the user meets the commitment made for the plurality of tasks and/or the predefined amount of time, then the system 102 may distribute rewards/incentives to the user. For the above example, consider the system 102 determines that if the user completes 10 tasks within ten days then the user will be provided with additional payment. The system 102 will check the total number of tasks completed at the end of tenth day. If the user completes the ten tasks by the end of the tenth day, then system 102 may provide a 10 percent higher payment to the user. In another example, the incentives may comprise allowing the user to unlock or claim more tasks. Further, if the user completes the plurality of tasks and/or the amount of time committed within the time frame, then the system 102 may rate the user in the work management system. When the user completes the plurality of tasks and/or the amount of time committed within the time frame, the system 102 may increase the rating of the user in the work management system. The ratings may be increased such that the system 102 may consider the user when assigning future tasks. In another example, the eligibility of the user in the work management system may be increased for the tasks that may be available.

If the user fails to meet the commitments made, the system 102 may penalize the user. In other words, if the user fails to meet the commitment made, the system 102 may distribute disincentives to the user. In one example, the disincentives may comprise reducing the payments to the user for the tasks that the user may have committed to completing. For the above example, consider the system 102 determines that if the user completes 10 tasks within ten days then the user will be provided with additional payment. Further, the system 102 may determine that disincentives will be distributed if the user does not meet the commitment at the end of the time frame. For example, consider that the user committed to completing 10 tasks in ten days. At the end of tenth day, the system 102 will check the total number of tasks completed. If the user completes seven tasks by the end of tenth day, then the system 102 may reduce the payment by 30 percent to the user. In another example, if the user completes five tasks by the end of tenth day, then the system 102 may reduce the payment by 50 percent to the user. In another example, the rating of the user in the work management system may be decreased. The rating may be decreased so as to move down the user in a list of users who are next to be assigned tasks. In another example, the eligibility of the user in the work management system may be decreased for the tasks that may be available in the work management system. If the user continues to miss/default on their commitments for a pre-defined number of times, then the system 102 may ban/eliminate the user from the work management system entirely. In one example, if the user misses their commitments for a total of ten tasks, the system 102 may eliminate the user from the work management system. Further, if the user completes the plurality of tasks committed before the time frame then the system 102 may increase a grade of the user in the work management system. The grade may help the user to claim future tasks in the work management system.

Although the concepts of incentives and disincentives have been explained in a limited sense, the concepts of gamification may be incorporated to enhance the engagement of the user to use the system 102.

In one implementation, the system 102 may alert the user based on the analysis performed. The system 102 may alert the user when the user is not adhering to the commitment made. For the above example, when the user completed six tasks out of the ten tasks to which the user committed as of Aug. 8, 2015, the system 102 may alert the user that the number of tasks completed is below the average number of tasks needed to fulfill the commitment. Further, the system 102 may alert the user of the number of tasks or the amount of time spent within the time frame as compared to the plurality of tasks or the predefined amount time to which the user has committed, respectively. In one example, the system 102 may send a message to the user reminding him/her of his/her commitment. For example, the system 102 may send alerts to the user at a frequency of one time in a day or week. The system 102 may send the alert/notification/reminder to the user via an email or using a PM service. The alert/notification/reminder may comprise the number of tasks that are incomplete as compared to plurality of tasks that the user has committed to completing.

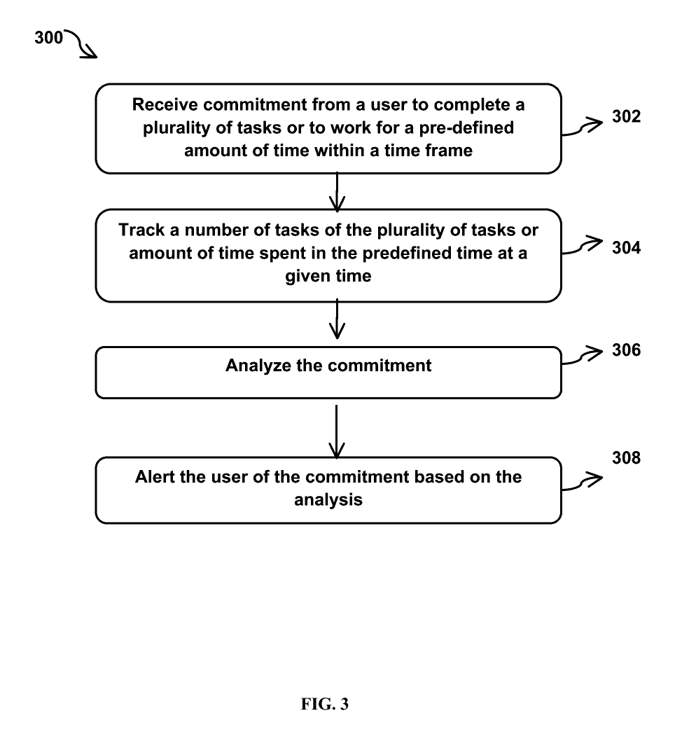

Referring now to FIG. 3, a method 300 for tracking commitment made by a user is shown, in accordance with an embodiment of the present disclosure. The method 300 may be described in the general context of computer executable instructions. Generally, computer executable instructions can include routines, programs, objects, components, data structures, procedures, modules, functions, etc., that perform particular functions or implement particular abstract data types. The method 300 may also be practiced in a distributed computing environment where functions are performed by remote processing devices that are linked through a communications network. In a distributed computing environment, computer executable instructions may be located in both local and remote computer storage media, including memory storage devices.

The order in which the method 300 is described and is not intended to be construed as a limitation, and any number of the described method blocks can be combined in any order to implement the method 300 or alternate methods.

Additionally, individual blocks may be deleted from the method 300 without departing from the spirit and scope of the disclosure described herein. Furthermore, the method may be implemented in any suitable hardware, software, firmware, or combination thereof. However, for ease of explanation, in the embodiments described below, the method 300 may be implemented in the above-described system 102.

At step/block 302, a commitment from a user is received to complete a plurality of tasks or to work for a pre-defined amount of time within a time frame.

At step/block 304, number of tasks of the plurality of tasks or amount of time spent in the pre-defined amount of time, at a given time is tracked.

At step/block 306, the commitment made is analyzed by comparing the number of tasks completed or the amount of time spent with the plurality of tasks or the pre-defined amount of time as committed.

At step/block 208, an alert is sent to the user reminding them of their progress in meeting the commitment based on the analysis.

Although implementations of system and method for tracking commitment made by a user have been described in language specific to structural features and/or methods, it is to be understood that the appended description is not necessarily limited to the specific features or methods described. Rather, the specific features and methods are disclosed as examples of implementations for tracking the commitments made by a user.

1. A method for tracking a commitment made by a user, the method comprising:
receiving, by a processor, a commitment from a user to complete a plurality of tasks or to work for a pre-defined amount of time within a time frame;
tracking, by the processor, a number of tasks of the plurality of tasks or amount of time spent in the pre-defined amount of time, at a given time, wherein the given time is a time within or after the time frame;
analyzing, by the processor, the commitment made by comparing the number of tasks completed or the amount of time spent with the plurality of tasks or the pre-defined amount of time as committed;
alerting, by the processor, the user of their progress in meeting the commitment based on the analysis; and
changing, based on a rating of the user's performance, at least one of the user's position on a list of users who are next to be assigned tasks and the user's compensation, the user provided greater or lesser compensation for performance greater or lesser, respectively, than initially committed.

2. The method of claim 1, further comprising selecting the plurality of tasks from a database.

3. The method of claim 1, further comprising distributing incentives based on the number of tasks or the amount of time spent at the end of the time frame, wherein the incentives are distributed when the number of tasks or the amount of time spent is completed as committed.

4. The method of claim 1, further comprising distributing disincentives based on the number of tasks or the amount of time spent at the time frame, wherein the disincentives are distributed when the number of tasks or the amount of time spent is not completed as committed.

5. The method of claim 1, further comprising modifying, by the processor, at least one of the plurality of tasks and the pre-defined amount of time committed within the time frame.

6. The method of claim 1, further comprising rating the user based on the number of tasks of the plurality of tasks completed or the amount of time spent in the pre-defined time committed within the time frame.

7. A system for tracking a commitment made by a user, the system comprising:
a processor; and
a memory, coupled to the processor, wherein the processor executes program instructions stored in the memory, to:
receive a commitment from a user to complete a plurality of tasks or to work for a pre-defined amount of time within a time frame;
track a number of tasks of the plurality of tasks or amount of time spent in the pre-defined amount of time, at a given time, wherein the given time is indicative of a time within or after the time frame;
analyze the commitment made by comparing the number of tasks completed or the amount of time spent with the plurality of tasks or the pre-defined amount of time as committed;
alert the user of their progress in meeting the commitment based on the analysis; and
change, based on a rating of the user's performance, at least one of the user's position on a list of users who are next to be assigned tasks and the user's compensation, the user provided greater or lesser compensation for performance greater or lesser, respectively, than initially committed.

8. The system of claim 8, wherein the processor further executes the program instructions to select the plurality of tasks from a database.

9. The system of claim 9, wherein the plurality of tasks is selected based on a qualification of the user.

10. The system of claim 8, wherein the processor further executes the program instructions to distribute incentives based on the number of tasks or the amount of time spent at the end of the time frame, wherein the incentives are distributed when the number of tasks or the amount of time spent is completed as committed.

11. The system of claim 8, wherein the processor further executes the program instructions to distribute disincentives based on the number of tasks or the amount of time spent at the time frame, wherein the disincentives are distributed when the number of tasks or the amount of time spent is not completed as committed.

12. The system of claim 10, wherein the processor further executes the program instructions to modify at least one of the plurality of tasks and the pre-defined amount of time committed within the time frame.

13. The system of claim 10, wherein the processor further executes the program instructions to rate the user based on the number of tasks of the plurality of tasks completed or the amount of time spent in the pre-defined time committed within the time frame.

14. A non-transitory computer readable medium embodying a program executable in a computing device for tracking a commitment made by a user, the program comprising:
a program code for receiving a commitment from a user to complete a plurality of tasks or to work for a pre-defined amount of time within a time frame;
a program code for tracking a number of tasks of the plurality of tasks or amount of time spent in the pre-defined amount of time, at a given time, wherein the given time is a time within or after the time frame;
a program code for analyzing the commitment made by comparing the number of tasks completed or the amount of time spent with the plurality of tasks or the pre-defined amount of time as committed;
a program code for alerting the user of their progress in meeting the commitment based on the analysis; and
a program code for changing, based on a rating of the user's performance, at least one of the user's position on a list of users who are next to be assigned tasks and the user's compensation, the user provided greater or lesser compensation for performance greater or lesser, respectively, than initially committed.
